(19) United States
(12) Patent Application Publication
(10) Pub. No.: US 2026/0116262 A1
(43) Pub. Date: Apr. 30, 2026

(54) Method And Device For Controlling Fuel Cell Power Generation During Regenerative Braking Using Forward Driving Information Of A Fuel Cell Vehicle

(71) Applicants: Hyundai Motor Company, Seoul (KR); Kia Corporation, Seoul (KR)

(72) Inventor: Sang Pil Jang, Hwaseong-Si (KR)

(21) Appl. No.: 19/080,143

(22) Filed: Mar. 14, 2025

(30) Foreign Application Priority Data
Oct. 31, 2024 (KR) 10-2024-0152373

(51) Int. Cl. B60L 58/40; B60L 7/10; B60L 50/75; H01M 8/04537; H01M 8/04858

(52) U.S. Cl. CPC B60L 58/40; B60L 7/10; B60L 50/75; H01M 8/04626; H01M 8/04932; B60L 2240/642; H01M 2250/20

(57) ABSTRACT

A method for controlling fuel cell power generation of a vehicle is introduced. The method may comprise obtaining driving information about at least two upcoming segments of a road, wherein the at least two upcoming segments are segments of the road to be driven by the vehicle driving on a current segment. The method may further comprise estimating, based on the obtained driving information, a required fuel cell output value of the current segment. The method may also comprise determining, based on the current segment being a segment for regenerative braking and based on the required fuel cell output value, whether to perform fuel cell power generation control of the vehicle. Based on the determining, the method may control power generation of a fuel cell of the vehicle.

### CROSS REFERENCE TO RELATED APPLICATION

The present application claims the benefit of priority to a Korean application 10-2024-0152373, filed in the Korean Intellectual Property Office on Oct. 31, 2024, the entire contents of which are incorporated herein by reference for all purposes.

### TECHNICAL FIELD

The present disclosure relates to a method and device for controlling fuel cell power generation during generative braking by using forward driving information of a fuel cell vehicle. More particularly, the present disclosure relates to a method and device for controlling fuel cell power generation during generative braking to secure a battery state of charge (SOC) before uphill driving in consideration of a moving object speed limit of a forward driving road, whether there is a gradient, and gradient data, which are acquired from a peripheral device of a moving object.

### BACKGROUND

The matters described in this Background section are only for enhancement of understanding of the background of the disclosure, and should not be taken as acknowledgment that they correspond to prior art already known to those skilled in the art.

A vehicle (or ‘moving object’) may be controlled depending on a current state of the moving object and a current driver's will. In a fuel cell power generation control method for a commercial fuel cell electric vehicle (FCEV), an FC power map according to an SOC of a high-voltage battery may be determined by calculating a vehicle output power demand based on a driver's acceleration pedal engagement amount and a service output power of vehicle accessories.

Specifically, a commercial FCEV may control fuel cell power generation by calculating a vehicle output power demand based on a driver's acceleration pedal engagement amount and a service output power of vehicle accessories and thus by determining an FC power map according to an SOC of a high-voltage battery. In this case, even when a forward driving road to be driven on in future is a long uphill segment or a long downhill segment, as power is generated merely by the FC power map in a current driving segment, there may be a problem in that a battery SOC necessary for the future driving segment is not sufficiently secured.

For example, the commercial FCEV (e.g., large FC trucks and large FC buses) may use high drive motor outputs during long uphill driving because its heavy weight, so that both a fuel cell power generation output and a battery discharge output may be required. In case fuel cell power generation is not controlled, a battery output value is already low during long uphill driving, and thus the battery may be discharged to an output limit before the end of a long uphill. Furthermore, a vehicle is driven only by a fuel cell power generation output, the velocity of the vehicle may be lowered.

In addition, when an expected battery output value required for a forward driving segment is predicted, the expected battery output value is predicted neither by dividing the forward driving segment into at least two or more segments and nor by considering an uphill/downhill change of the forward driving segment, and thus an error may occur that a required battery value is not accurately calculated. That is, even when a battery needs to be charged in a forward driving segment divided into at least two segments, an existing FCEV may limit fuel cell power generation to a minimum level for stable battery charge during regenerative braking in a current driving segment and thus may fail to achieve a required battery output value for the forward driving segment.

Accordingly, it is desirable to provide a method that divides a forwarding driving road into at least two segments, determine an expected battery output value by using information on each segment of the forward driving road acquired from a peripheral device of a vehicle and controls fuel cell power generation according to the determined expected battery output even if a current driving segment is a regenerative braking segment.

### SUMMARY

According to the present disclosure, a method for controlling fuel cell power generation of a vehicle, the method may comprise obtaining driving information about at least two upcoming segments of a road, wherein the at least two upcoming segments of the road are segments of the road to be driven by the vehicle driving on a current segment of the road, estimating, based on the obtained driving information, a required fuel cell output value of the current segment, determining, based on the current segment being a segment for regenerative braking and based on the required fuel cell output value, whether to perform fuel cell power generation control of the vehicle, and controlling, based on the determining, power generation of a fuel cell of the vehicle.

The obtained driving information is used to determine an expected battery output value for each of the at least two upcoming segments, and wherein, the driving information is obtained based on at least the current segment, a first upcoming segment, and a second upcoming segment.

The determining whether to perform fuel cell power generation control may further comprise estimating, based on the current segment being the segment for regenerative braking, an expected battery output value and an expected battery charge/discharge energy demand, wherein the expected battery output value corresponds to an expected battery charge/discharge output value, wherein the expected battery charge/discharge energy demand is determined by multiplying the expected battery charge/discharge output value and an expected future driving time for the at least two upcoming segments, and wherein a required battery charge/discharge output value is determined by dividing the expected battery charge/discharge energy demand by an expected driving time for the current segment.

The estimating the required fuel cell output value may comprise correcting the required battery charge/discharge output value by a required vehicle output value for driving of the vehicle, wherein the required fuel cell output value of the current segment is determined based on a sum of the required vehicle output value and the required battery charge/discharge output value.

The method may further comprise determining whether to perform fuel cell power generation control based on a regenerative braking of the vehicle in the current segment by comparing the required fuel cell output value of the current segment and a determined fuel cell power generation demand value during the regenerative braking.

The method may further comprise, based on a necessity of battery charge in the current segment, determining whether to perform fuel cell power generation control based on a regenerative braking of the vehicle in the current segment by comparing a value and a determined battery charge margin during the regenerative braking, wherein the value is obtained by subtracting a current motor regenerative braking output value from a battery charge limit value.

The fuel cell power generation control is configured to be performed during the regenerative braking in the current segment, based on the value being greater than a threshold value.

The fuel cell power generation control is prohibited during the regenerative braking, based on a battery charge reaching or exceeding a predetermined threshold during the regenerative braking.

The first upcoming segment and the second upcoming segment correspond to an uphill, and the expected battery output value corresponds to an expected battery discharge output value, and wherein the expected battery discharge output value is determined by multiplying a battery efficiency and a value that is obtained by subtracting an expected fuel cell power generation output value from an expected gradient driving output value during driving of the vehicle.

The first upcoming segment and the second upcoming segment correspond to a downhill, and the expected battery output value corresponds to an expected battery charge output value, and wherein the expected battery charge output value is obtained by dividing an expected gradient driving output value by a battery efficiency.

According to the present disclosure, an apparatus for controlling fuel cell power generation of a vehicle, the apparatus may comprise a peripheral device configured to obtain driving information about at least two upcoming segments of a road, wherein the at least two upcoming segments of the road are segments of the road to be driven by the vehicle driving on a current segment of the road, and wherein the driving information may comprise at least one of a speed limit of a moving object on the road or a presence of a gradient and gradient-related data, a processor, and a memory storing at least one instruction that, when executed by the processor, is configured to cause the apparatus to estimate, based on the obtained driving information, a required fuel cell output value of the current segment, determine, based on the current segment being a segment for regenerative braking and based on the required fuel cell output value, whether to perform fuel cell power generation control of the vehicle, and control, based on the determination, power generation of a fuel cell of the vehicle.

The obtained driving information is used to determine an expected battery output value for each of the at least two upcoming segments, and wherein, the driving information is obtained based on at least the current segment, a first upcoming segment, and a second upcoming segment.

The at least one instruction, when executed by the processor, is further configured to cause the apparatus to determine whether to perform fuel cell power generation control by estimating, based on the current segment being the segment for regenerative braking, an expected battery output value and an expected battery charge/discharge energy demand, wherein the expected battery output value corresponds to an expected battery charge/discharge output value, wherein the expected battery charge/discharge energy demand is determined by multiplying the expected battery charge/discharge output value and an expected future driving time for the at least two upcoming segments, and wherein a required battery charge/discharge output value is determined by dividing the expected battery charge/discharge energy demand by an expected driving time for the current segment.

The at least one instruction, when executed by the processor, is further configured to cause the apparatus to estimate the required fuel cell output value by correcting the required battery charge/discharge output value by a required vehicle output value for driving of the vehicle, wherein the required fuel cell output value of the current segment is determined based on a sum of the required vehicle output value and the required battery charge/discharge output value.

The at least one instruction, when executed by the processor, is further configured to cause the apparatus to determine whether to perform fuel cell power generation control based on a regenerative braking of the vehicle in the current segment by comparing the required fuel cell output value of the current segment and a determined fuel cell power generation demand value during the regenerative braking.

The at least one instruction, when executed by the processor, is further configured to cause the apparatus to, based on a necessity of battery charge in the current segment, determine whether to perform fuel cell power generation control, based on a regenerative braking of the vehicle in the current segment, by comparing a value and a determined battery charge margin during the regenerative braking, wherein the value is obtained by subtracting a current motor regenerative braking output value from a battery charge limit value.

The at least one instruction, when executed by the processor, is further configured to cause the apparatus to determine the fuel cell power generation control not to be performed during the regenerative braking, based on a battery charge reaching or exceeding a predetermined threshold during the regenerative braking.

The first upcoming segment and the second upcoming segment correspond to an uphill, and the expected battery output value corresponds to an expected battery discharge output value, and wherein the expected battery discharge output value is determined by multiplying a battery efficiency and a value that is obtained by subtracting an expected fuel cell power generation output value from an expected gradient driving output value during driving of the vehicle.

The first upcoming segment and the second upcoming segment correspond to a downhill, and the expected battery output value corresponds to an expected battery charge output value, and wherein the expected battery charge output value is obtained by dividing an expected gradient driving output value by a battery efficiency.

According to the present disclosure, a vehicle may comprise one or more sensors configured to obtain gradient information about at least two upcoming segments of a road may comprise a current segment on which the vehicle is driving, a battery, and a processor, and memory storing instructions that, when executed by the processor, configure the vehicle to determine a regenerative charging amount of the battery by performing a regenerative braking operation during driving of the vehicle on the current segment of the road, determine, based the gradient information and based on the regenerative charging amount, whether to charge the battery by additional power generated by a fuel cell of the vehicle or to discharge the battery, and control an operation of the vehicle by controlling, based on a determination to charge the battery by the additional power generated by the fuel cell, an amount of power generated by the fuel cell of the vehicle, or controlling, based on a determination to discharge the battery, an amount of charge to be discharged from the battery.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 shows an example of constituent modules of a vehicle equipped with a fuel cell power generation control device according to an example of the present disclosure.

FIG. 2A and FIG. 2B show an example of a method for controlling fuel cell power generation according to regenerative braking of a vehicle according to an example of the present disclosure.

FIG. 3A and FIG. 3B show an example of a predictive battery SOC control process of a vehicle according to a current driving segment and at least two or more forwarding driving segments for fuel cell power generation control according to an example of the present disclosure.

FIG. 4 show an example of an operating mechanism during regenerative braking for securing a battery SOC before uphill driving by a fuel cell power generation control device according to an example of the present disclosure.

FIG. 5A and FIG. 5B show an example of test data according to whether or not fuel cell power generation is controlled during regenerative braking of a vehicle in a current driving segment according to an example of the present disclosure.

### DETAILED DESCRIPTION

Hereinafter, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

Here, a method can be suggested to minimize driving issues caused by smart power control by limiting the target battery's SOC (State of Charge) change or adjusting the charging/discharging rate weight based on the reliability of the vehicle's driving path. The reliability of the driving path refers to the trustworthiness of the gradient information of the current driving path received by the smart power control logic. Even if the driving path changes, the reliability is considered high if the gradient information remains similar. For example, when transitioning from one uphill to another uphill path, the reliability is judged to be high. However, if the gradient information is likely to reverse due to a path change, such as transitioning from uphill to downhill, the reliability is considered low.

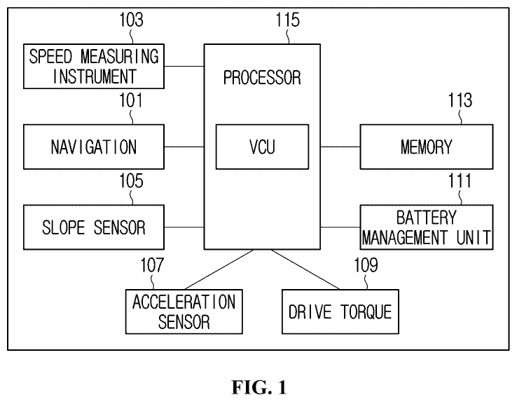

Hereinafter, a fuel cell power generation control device, which controls fuel cell power generation during regenerative braking of a vehicle according to an example of the present disclosure, will be described with reference to FIG. 1.

FIG. 1 shows an example of constituent modules of a fuel cell power generation control device of a vehicle, which controls fuel cell power generation during regenerative braking according to an example of the present disclosure.

A fuel cell power generation control device may be mounted in a commercial hydrogen electric vehicle such as a large hydrogen electric truck. A smart power control device may receive information on the presence/absence of a road gradient of a front point a predetermined distance or more away from a vehicle, a distance and a speed limit of the vehicle, divide a forward driving road into two or more segments (e.g., upcoming segments of the road on which the vehicle is driving), calculate an expected battery output value for each segment of the forward driving road, and control a fuel cell during regenerative braking of the vehicle, when necessary. Herein, the expected battery output value may be an expected battery charge or discharge output value depending on whether a forward driving segment is uphill or downhill.

The fuel cell power generation control device may include a peripheral device, which includes, a navigation unit 101 (e.g., a navigation device, such as a Global Positioning System (GPS) device), a speed measuring instrument 103, a slope sensor 105, an acceleration sensor 107 and a drive torque 109, a battery management unit 111 (e.g., a battery management device, such as battery management systems including one or more processors, controllers, and/or sensors to monitor and manage one or more batteries and battery cells), and a memory 113. The peripheral device is a device for acquiring forward driving information of the vehicle and may further include various devices other than the constituent elements illustrated in FIG. 1. In this regard, the connected car Navigation Cockpit (ccNc) (e.g., ccNc developed by the applicant and/or any other modified ccNc or similar devices) may be provided in the vehicle and perform a function of acquiring the forward driving information. Accordingly, the forward driving information according to the present disclosure may be acquired from the ccNc.

The navigation unit 101 may send out road information and/or repeated driving route information. Road information may include information indicating whether or not there is a gradient on a forward driving road on which a vehicle is driving, a driving distance, a vehicle speed limit, and the like. Repeated driving route information may be a route registered by a user or an automatically registered route based on driving repeated a predetermined number of times.

Apart from the navigation unit 101, the fuel cell power generation control device of the vehicle may include, as a peripheral device, the speed measuring instrument 103, the slope sensor 105, the acceleration sensor 107, and the drive torque 109. The speed measuring instrument 103 may measure a driving speed of the vehicle, and the acceleration sensor 107 may measure not only a driving direction of the vehicle but also an acceleration in a different direction from the driving direction. In addition, a weight of the vehicle may be calculated through the acceleration sensor 107 and the drive torque 109.

The battery management unit 111 may play a role to enhance energy efficiency by optimally managing a state of charge (SOC) of a vehicle battery. Such a battery management unit may be implemented as a battery management system (BMS). The battery management unit may monitor the voltage, current and/or temperature of a vehicle battery (e.g., in real time) by using sensors. The battery management unit may prevent overcharge and overdischarge of a vehicle battery through the monitoring process. The battery management unit may calculate a SOC of a vehicle battery (battery SOC) by current and/or voltage measured by sensors. A vehicle battery may supply a power source to an electrical device mounted in a vehicle such as an electronic control unit (ECU) and/or a drive motor.

The memory 113 may store an application and various types of data for controlling a vehicle and at a request of a processor, load the application or read and record data. The memory may include a non-volatile memory and a volatile memory.

The processor 115 may perform overall control of the moving object (e.g., a vehicle). The processor 115 may have at least one processing module, and each control-related function may be implemented in a single processing module or be implemented in a corresponding processing module among a plurality of modules. In relation to the present disclosure, the processor 115 may control the moving object to control fuel cell power generation by using an application, an instruction and data stored in the memory.

Specifically, the processor 115 may acquire at least one of a vehicle speed limit on a forward driving road, whether the forward driving road has a gradient, and gradient data as forward driving information during driving of the vehicle and calculate a total amount of expected battery output energy based on the acquired forward driving information. The processor may determine a fuel cell power generation output value in a current driving segment in order to charge or discharge a battery based on the total amount of expected battery output energy,

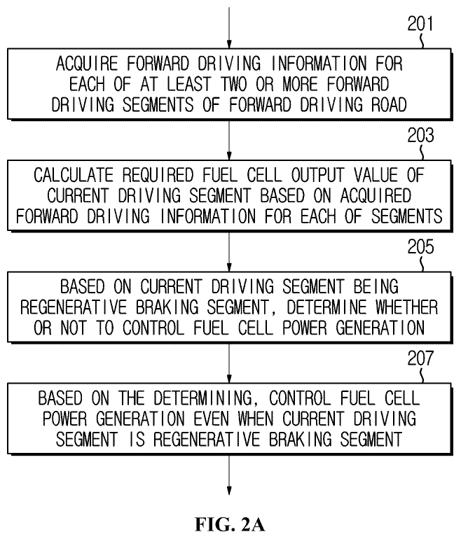

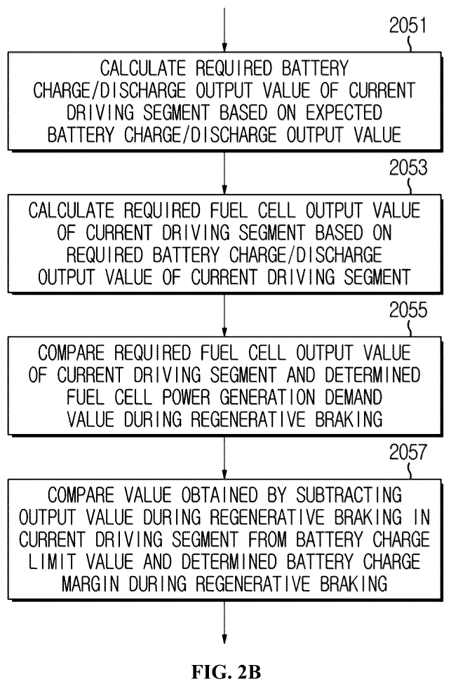

The fuel cell power generation control device of the vehicle according to the present disclosure may be a device configured to implement processing of fuel cell power generation control through a processor by including at least the speed measuring instrument 103, the navigation unit 101, the slope sensor 105, the acceleration sensor 107, the drive torque 109, the memory 113, the battery management unit 111 and the processor 115. The processing may be implemented by at least a portion of the processor such as at least one processing module that may function as a VCU. The above-described processing of the processor will be described in detail through FIG. 2A and FIG. 2B.

The fuel cell power generation control device may process the forward driving information dynamically to enable predictive power enhancement or optimization. In real-time operation, the peripheral devices of the vehicle may communicate with the processor 115 to ensure that gradient information, vehicle weight estimation, and speed constraints are continuously monitored. The drive torque 109 and the acceleration sensor 107 may assist in estimating the vehicle's mass, allowing the system to adjust power generation needs based on load variations. The processor 115 may integrate this data with road gradient predictions from the slope sensor 105 and the navigation unit 101, ensuring that fuel cell power generation is adjusted ahead of upcoming high-load segments, such as steep inclines. This anticipatory control strategy may secure the necessary battery state of charge (SOC) by adjusting power output in advance, preventing sudden energy deficits during uphill driving. The system may also assess power regeneration limits during braking to determine whether supplementary fuel cell power generation is needed to maintain battery stability. By integrating real-time sensor feedback, the system may ensure that fuel cell operation is dynamically optimized for both efficiency and performance, reducing dependency on instantaneous driver acceleration input alone.

FIG. 2A and FIG. 2B show an example of a method for controlling fuel cell power generation according to regenerative braking of a vehicle according to an example of the present disclosure.

Referring to FIG. 2A, a method for controlling fuel cell power generation according to regenerative braking of a vehicle according to the present disclosure may include acquiring forward driving information for each of at least two or more forward driving segments (e.g., two or more upcoming segments) of a forward driving road (201), calculating a required fuel cell output value of a current driving segment based on the acquired forward driving information for each of the segments (203), based on the current driving segment being a regenerative braking segment, determining whether or not to control fuel cell power generation (205), and based on the determining, controlling the fuel cell power generation even when the current driving segment is a regenerative braking segment (207).

First, according to step S201, the acquiring of the forward driving information on each of the two or more forward driving segments of the forward driving road is performed by peripheral devices of the vehicle.

For example, the navigation unit 101 may provide information on a vehicle speed limit according to each segment of a forward driving road, a driving distance of a vehicle according to each forward driving segment, whether the forward driving road has a gradient in each segment, and an angle of a gradient. A velocity measuring instrument may provide a current driving velocity of a moving object. A slope sensor may provide information regarding whether there is a gradient in a current driving segment on which a vehicle is driving, and an angle.

That is, it is possible to disclose the operation of a mechanism in which the processor 115 calculates an expected battery output value by receiving, as inputs, information on two or more distinct segments of a first forwarding driving segment and a second forward driving segment, that is, whether each of the segments has a gradient, a driving distance, and a speed limit of the vehicle from peripheral devices, and then determines whether or not to control fuel cell power generation, when a current driving segment is a regenerative braking segment.

At step S203, the calculating of the required fuel cell output value of the current driving segment based on the acquired forward driving information for each of the segments may be a step at which a required battery charge/discharge output value and a current required vehicle output value are added based on information acquired from peripheral devices of the vehicle.

The required battery charge/discharge output value of the current driving segment may be obtained by dividing an expected battery energy demand by a driving time of the current driving segment. The expected battery charge/discharge energy demand may be obtained by multiplying an expected battery output value and a future driving time. Herein, the expected battery output value may be an expected battery discharge output value when the first forward driving segment and the second forward driving segment are longer than a threshold distance and an uphill (an uphill road) and may be an expected battery charge output value when the first forward driving segment and the second forward driving segment are longer than the threshold distance and downhill (a downhill road).

At step S205, the determining of whether or not to control fuel cell power generation based on the current driving segment being a regenerative braking segment may be performed through a fuel cell power generation control process based on an expected battery SOC change according to the first forward driving segment and the second forward driving segment. Regenerative braking may be performed in a current driving segment when the first forward driving segment and the second forward driving segment are longer than the threshold distance and a downhill and battery charge is expected.

Finally, according to step S207, the controlling of the fuel cell power generation, based on the determination, even when the current driving segment is a regenerative braking segment may be performed by steps of FIG. 2B.

Referring to FIG. 2B, step S205 may include calculating a required battery charge/discharge output value of the current driving segment based on the expected battery charge/discharge output value (2051), calculating a required fuel cell output value of the current driving segment based on the required battery charge/discharge output value of the current driving segment (2053), comparing the required fuel cell output value of the current driving segment and a determined fuel cell power generation demand value during regenerative braking (2055), and comparing a value (e.g., a remaining charging capacity value of a battery) obtained by subtracting an output value during regenerative braking in the current driving segment from a battery charge limit value and a determined battery charge margin during regenerative braking (2057). The determined fuel cell power generation demand value may represent a value of additional fuel cell power required to achieve a target battery state of charge (SoC) during the regenerative braking (2055). The battery charge limit value corresponds to a maximum allowable power input that the battery may safely accept during charging, including charging from the regenerative braking and additional fuel cell power generation. The determined battery charge margin corresponds to a remaining capacity limit of a battery to safely accept additional charging power.

According to FIG. 2B, first, step S205 includes calculating, according to step S2051, the required battery charge/discharge output value of the current driving segment based on the expected battery charge/discharge output value. In order to obtain the required battery charge/discharge output value, an expected battery charge/discharge energy amount and the expected battery charge/discharge output value are needed.

As the expected battery charge/discharge energy amount may be obtained by multiplying the expected battery charge/discharge output value and an expected future driving time, the expected battery output value may be obtained by a VCU through a moving object dynamics equation. For example the moving object dynamics equation may be Equation 1 below.

$${F}_{traction} = ( {F}_{drag} + {F}_{roll} + {F}_{grade} ) = 0.5 * ρ * {C}_{d} * A * {V}^{2} + mg * ( {C}_{r} cos θ + sin θ ) \qquad [ Equation 1 ]$$

Here, F_{traction} is a traction force, F_{drag} is air drag, Fᵣₒₗₗ is rolling resistance, and F_{grade} is gradability. m is a moving object weight, g is the acceleration of gravity, ρ is air density, Cd is an air resistance coefficient, A is a front area, and Cr is a rolling resistance coefficient.

Specifically, in case a navigation unit detects that a first forward driving road (e.g., the first forward driving segment) and a second forward driving road (e.g., the second forward driving segment) are longer than the threshold distance and an uphill, an expected battery discharge output value may be obtained by subtracting an expected fuel cell power generation output value from an expected gradient driving output value during driving of the vehicle. On the other hand, in case the navigation unit detects that the first forward driving road and the second forward driving road are longer than the threshold distance and a downhill, an expected battery charge output value may be an expected gradient driving output value during regenerative braking.

At step S2053, the calculating of the required fuel cell output value of the current driving segment based on the required battery charge/discharge output value of the current driving segment may be determined by adding a current required vehicle output value to the required battery charge/discharge output value of the current driving segment obtained through step S2053. Herein, the required vehicle output value may be a value that is calculated based on a driver's acceleration pedal engagement amount and a service output power of vehicle accessories in a commercial fuel cell vehicle that is currently under mass production.

At step S2055, the comparing of the required fuel cell output value of the current driving segment and the determined fuel cell power generation demand value during regenerative braking may determine whether the required fuel cell output value of the current driving segment requires a high level of battery charge, based on expected battery output values calculated for the first forward driving segment and the second forward driving segment.

In case the required fuel cell output value of the current driving segment is greater than the determined fuel cell power generation demand value during regenerative braking, whether or not to allow fuel cell power generation control during regenerative braking may be determined by performing step S2057, that is, by comparing the value obtained by subtracting the output value during regenerative braking in the current driving segment from the battery charge limit value and the determined battery charge margin during regenerative braking. On the other hand, in case the determined fuel cell power generation demand value during regenerative braking is greater than the required fuel cell output value of the current driving segment, fuel cell power generation control may not be performed during regenerative braking.

At step S2057, the comparing of the value obtained by subtracting the output value during regenerative braking in the current driving segment from the battery charge limit value and the determined battery charge margin during regenerative braking may calculate a battery charge limit value even during battery charge by regenerative braking in the current driving segment in order to sufficiently secure a required battery output value, when the first forward driving segment and the second forward driving segment are uphill, and determine even during regenerative braking whether or not to control fuel cell power generation.

As shown in FIG. 2A, the control logic for fuel cell power generation may consider predicted energy requirements beyond the immediate next driving segment. When determining whether to initiate fuel cell power generation, the system may evaluate not only the battery's current SOC but also the expected power demand in future road segments. Specifically, if an upcoming incline is detected, the system may preemptively increase fuel cell power generation during a regenerative braking of the vehicle, even when the current segment does not immediately require additional charging. This may ensure that the battery maintains sufficient charge before reaching a high-energy-demand segment, preventing excessive reliance on fuel cell output at the last moment.

As shown in FIG. 2B, the SOC adjustment logic may account for predicted road gradients, modifying the required fuel cell output value accordingly. The processor may determine a target SOC by analyzing the forward driving information, including road slope data and expected energy consumption rates. The system then may determine a required fuel cell power output value based on the projected energy needs for the upcoming driving segments. This approach may ensure that fuel cell power generation is enhanced not just for the immediate segment but for a continuous driving range, allowing for a more efficient power distribution strategy.

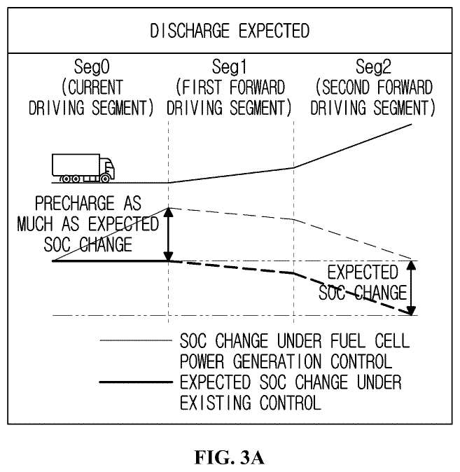

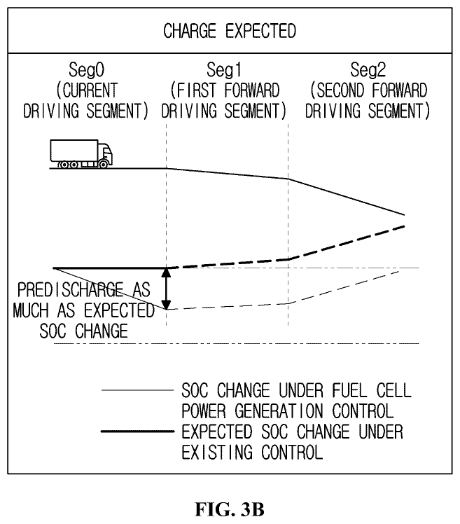

FIG. 3A and FIG. 3B show an example of a predictive battery SOC control process for a vehicle according to a current driving segment and each of at least two or more forwarding driving segments for fuel cell power generation control according to another example of the present disclosure.

Referring to FIG. 3A and FIG. 3B, the calculating of the required fuel cell output value of the current driving segment at step S201 and step S203 may be described. That is, according to the present disclosure, an expected battery SOC change may be predicted according to whether each of a forward driving road has a gradient and a degree thereof. Accordingly, the expected battery SOC change may be converted into a required battery charge/discharge output value in a current driving segment and thus fuel cell power generation output may be controlled, and a required fuel cell output value of the current driving segment may be calculated.

Specifically, FIG. 3A is a fuel cell power generation control process when a first forward driving segment and a second forward driving segment are longer than the threshold distance and an uphill and an expected battery output value corresponding to an amount of battery charge that is expected to be discharged. First, in order to obtain a required battery charge output value of a current driving segment, an expected battery charge output value of each segment may be calculated when the first forward driving segment and the second forward driving segment are longer than the threshold distance and an uphill. The expected battery charge output value of each forward driving segment may be an expected gradient driving output value during regenerative braking. The required battery charge output value of the current segment may be obtained by dividing the expected battery charge output value of each forward driving segment by an expected current driving time.

For example, in FIG. 3A, a driving segment is divided into a current driving segment Seg 0 and at least one forward driving segment, and the forward driving segment is divided again into a first driving segment 1 Seg 1 and a second driving segment 2 Seg 2. In the current driving segment Seg 0, an expected amount of battery SOC change may be calculated for the first forward driving segment and the second forward driving segment of a vehicle, and charging of the battery may be performed in advance to increase the battery charge level so that the battery is sufficiently charged to drive the vehicle on the first forward driving segment and the second forward driving segment. In a fuel cell control method of the related art, an amount of battery SOC change may not be maintained but have a value below a preset reference point, and thus discharge may occur. Specifically, the first driving segment 1 Seg 1 is a long slight uphill (e.g., an uphill having a distance longer than a threshold distance and having a slope inclination less than a threshold angle), on which a battery SOC value is slightly discharged at the preset reference point, and the second driving segment 2 Seg 2 is a long steep uphill (e.g., an uphill having a distance longer than a threshold distance and having a slope inclination greater than a threshold angle), on which the battery SOC value may be more drastically discharged at the preset reference point than in the first driving segment 1.

On the other hand, in case fuel cell power control is performed, since charge may be performed in a current driving segment as much as an amount of battery SOC change, even driving on a long uphill may not cause a battery SOC value to be lowered below a preset reference value. A required battery charge energy amount may be calculated by multiplying the calculated expected battery charge output value of the forward driving segment and an expected future driving time. A required battery charge value of the current driving segment may be obtained by dividing the required battery charge energy amount over time. Finally, a required fuel cell output value of the current driving segment may be calculated by adding the required battery charge value of the current driving segment and a required vehicle output value.

As shown in FIG. 3A, the system may preemptively increase battery SOC in the current driving segment when an upcoming gradient (incline) is detected in future driving segments. Specifically, the system utilizes ccNc forward driving information to determine whether the next road segment has an extended incline. If so, the required driving energy for the extended incline is determined, and the system may ensure that sufficient battery SOC is secured in advance to prevent power shortages. The preemptive SOC increase may be achieved by adjusting the fuel cell power generation strategy, even during a regenerative braking of the vehicle, ensuring that the vehicle does not rely solely on real-time fuel cell power output when climbing the extended incline.

FIG. 3B is a fuel cell power generation control process when a first forward driving segment and a second forward driving segment are longer than the threshold distance and a downhill and a battery SOC value corresponding to an amount of battery charge that is expected to be charged (e.g., by driving on the downhill). In order to obtain a required battery charge output value of a current driving segment, an expected battery discharge output value of each segment may be calculated when the first forward driving segment and the second forward driving segment are longer than the threshold distance and a downhill. The expected battery discharge output value of each segment may be calculated by subtracting an expected fuel cell power generation value from an expected gradient driving output value, when a moving object (e.g. a vehicle) is being driven. The required battery charge output value of the current segment may be obtained by dividing the expected battery discharge output value of each segment by an expected driving time of the current segment.

For example, in FIG. 3B, a driving segment is divided into a current driving segment Seg 0 and a forward driving segment, and the forward driving segment may be divided into a first driving segment 1 Seg 1 and a second driving segment 2 Seg 2. In the current driving segment Seg 0, an expected amount of battery SOC change may be calculated for the first forward driving segment and the second forward driving segment of a vehicle, and battery discharge may be performed in advance (e.g., to maintain the battery charge level below a threshold battery SOC while driving the vehicle on the forward driving segment). In a control method of the related art, an amount of battery SOC change may not be maintained but have a value exceeding a preset reference point, and thus overcharge may occur. Specifically, the first driving segment 1 Seg 1 is a long slight downhill (e.g., an uphill having a distance longer than a threshold distance and having a slope inclination less than a threshold angle), on which a battery SOC value is slightly charged at the preset reference point, and the second driving segment 2 Seg 2 is a long steep downhill (e.g., an uphill having a distance longer than a threshold distance and having a slope inclination greater than a threshold angle), on which the battery SOC value may be more drastically charged at the preset reference point than in the first driving segment 1.

On the other hand, in the case of a battery SOC correction device that performs fuel cell power control, since discharge may be performed in a current driving segment as much as an amount of battery SOC change, even driving on a long downhill may not cause a battery SOC value to exceed a preset reference value. A required battery discharge energy amount may be calculated by multiplying the calculated expected battery discharge output value of the forward driving segment and an expected future driving time. A required battery discharge value of the current driving segment may be obtained by dividing the required battery discharge energy amount over time. Finally, a required fuel cell output value of the current driving segment may be calculated by adding the required battery discharge value of the current driving segment and a required vehicle output value.

As shown in FIG. 3B, the system also enhances SOC before entering a long downhill segment. If the forward driving information indicates an upcoming downhill gradient, the system may limit unnecessary fuel cell power generation and allow the battery to store excess energy from a regenerative braking of the vehicle. The battery charging capacity may be adjusted dynamically to prevent overcharging, ensuring that regenerative braking energy is efficiently utilized. By integrating gradient-based SOC adjustments for both inclines and declines, the system may increase energy efficiency and prevent abrupt SOC fluctuations, leading to a more stable and predictable power distribution strategy.

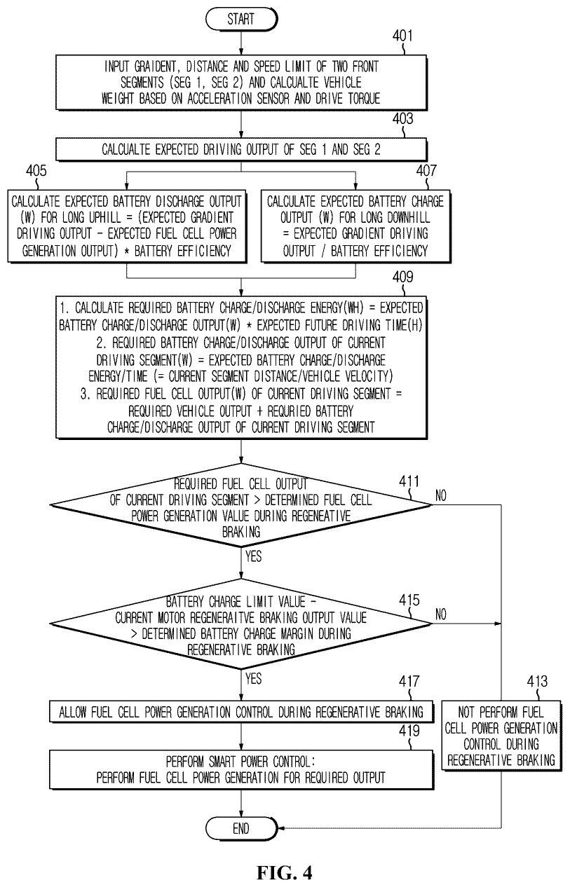

FIG. 4 show an example of an operating mechanism during regenerative braking for securing a battery SOC before uphill driving by a fuel cell power generation control device according to an example of the present disclosure.

Referring to FIG. 4, a method for controlling fuel cell power generation during specific regenerative braking may calculate an expected battery charge/discharge output value for a first forward driving segment and a second forward driving segment and perform fuel cell power generation control for battery charge even when a current driving segment is uphill and in a regenerative braking situation.

A process of controlling fuel cell power generation during regenerative braking may be described with reference to FIG. 4 as follows. First, the battery SOC correction device may be initiated by receiving, as inputs, information on whether two or more distinguished forward driving segments to be covered in the future have a gradient, a driving distance of each segment and a speed limit of a vehicle may be received from a peripheral device of the vehicle and receiving a weight of the vehicle from a vehicle acceleration sensor and a drive torque (401). For example, the peripheral device of the vehicle may be the above-described ccNc.

Expected gradient driving output values of a first forward driving segment Seg 1 and a second forward driving segment Seg 2 may be calculated by a vehicle dynamics equation as expressed by Equation 1 above (403). Herein, the expected gradient driving output value may be an expected battery output value.

Herein, in case a forward driving segment is long and uphill, the expected battery output value may be an expected battery discharge output value, which may be calculated by multiplying battery efficiency and a value obtained by subtracting an expected fuel cell power generation output value from the expected gradient driving output value (405). On the other hand, in case the forward driving segment is long and downhill, the expected battery output value may be an expected battery charge output value, which may be determined by dividing the expected gradient driving output value by battery efficiency (407).

At step S409, in order to obtain a required fuel cell output value of a current driving segment, a required battery charge/discharge energy amount and a required battery charge/discharge output value of the current driving segment may be calculated (409). The required fuel cell output value of the current driving segment may be determined by adding a required vehicle output value and the required battery charge/discharge output value of the current driving segment. Herein, the required battery charge/discharge output value of the current driving segment may be obtained by dividing an expected battery charge/discharge energy amount over time. The expected battery charge/discharge energy amount may be obtained by multiplying the expected battery charge/discharge output value and an expected future driving time.

The required fuel cell output value of the current driving segment, which is obtained at step S409 above, may be compared with a determined fuel cell power generation demand value during regenerative braking (411). If the required fuel cell output value of the current driving segment is greater, it may be determined that battery charge in the current driving segment is needed based on expected battery charge/discharge energy amounts that are predicted in the first forward driving segment and the second forward driving segment. Accordingly, step S411 may be performed to determine whether or not to allow fuel cell power generation control even when the current driving segment is a regenerative braking segment.

In a battery charge scenario based on regenerative braking (e.g., when driving on a downhill segment or a driver lowers speed), existing mass-produced fuel cell vehicles limit fuel cell power generation to a minimum level to stabilize battery charge even when there is a sufficient margin in battery charge limit. Herein, the determined fuel cell power generation demand value during regenerative braking may mean a criterion value for determining whether a battery SOC needs to be charged while uphill driving in a first forward driving segment and a second forward driving segment, in order to perform fuel cell power generation control even during regenerative braking. On the other hand, in case the determined fuel cell power generation demand value during regenerative braking is greater than the required fuel cell output value of the current driving segment, fuel cell power generation control may not be performed during regenerative braking in the current driving segment (413).

At step S411, in case the required fuel cell output value of the current driving segment is greater than the determined fuel cell power generation demand value during regenerative braking, a value obtained by subtracting a current motor regenerative braking output value from a battery charge limit value may be compared with a determined battery charge margin during regenerative braking (415). The current motor regenerative braking output value corresponds to amount of power generated during the regenerative braking at the current driving segment. This power may feed back into the battery for charging.

In case the value obtained by subtracting the current motor regenerative braking output value from the battery charge limit value is greater than the determined battery charge margin during regenerative braking, fuel cell power generation control may be allowed even when the current driving segment is a regenerative braking segment (417). On the other hand, in case the determined battery charge margin during regenerative braking is greater than the value obtained by subtracting the current motor regenerative braking output value from the battery charge limit value, fuel cell power generation control may not be performed when the current driving segment is a regenerative braking segment (413). Herein, the battery charge limit value may mean a minimum limit of fuel cell power generation amount for stability of battery charge when a vehicle is currently in a regenerative braking state. The current motor regenerative braking output value may mean a battery output value during regenerative braking in the current driving segment where the vehicle is running. The determined battery charge margin during regenerative braking is an expected battery output value, which is predicted to be necessary when the first forward driving segment and the second forward driving segment are uphill, and may mean a criterion value for determining that sufficient battery is secured for driving.

Smart power control may be performed to control fuel cell power generation by determining a battery charge margin to sufficiently secure a battery SOC required for the first forward driving segment and the second forward driving segment even when the battery is being charged by regenerative braking of the vehicle.

As shown in FIG. 4, the system may dynamically adjust fuel cell power generation during a regenerative braking of the vehicle based on the predicted SOC requirements for future driving segments. If the forward driving information indicates an upcoming high-energy-demand segment, such as an extended incline, the system may determine whether additional fuel cell power generation is necessary during the regenerative braking to secure sufficient SOC. Unlike other fuel cell vehicles, which may reduce or minimize fuel cell power output during the regenerative braking, this system may allow supplementary fuel cell power generation when the battery charge margin permits, ensuring that the vehicle enters the extended incline with a sufficient or optimal SOC level.

Conversely, when the system predicts a downhill segment in the upcoming driving range, the system may limit unnecessary fuel cell power generation during a regenerative braking of the vehicle to prevent overcharging. The fuel cell control logic may integrate real-time SOC monitoring and predicted power requirements, dynamically adjusting the power generation strategy to maintain battery charge stability and improve energy efficiency.

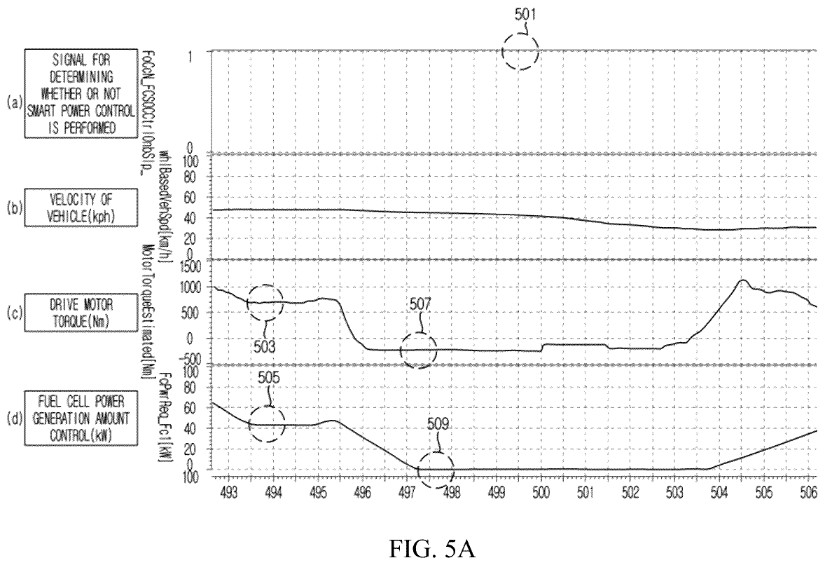

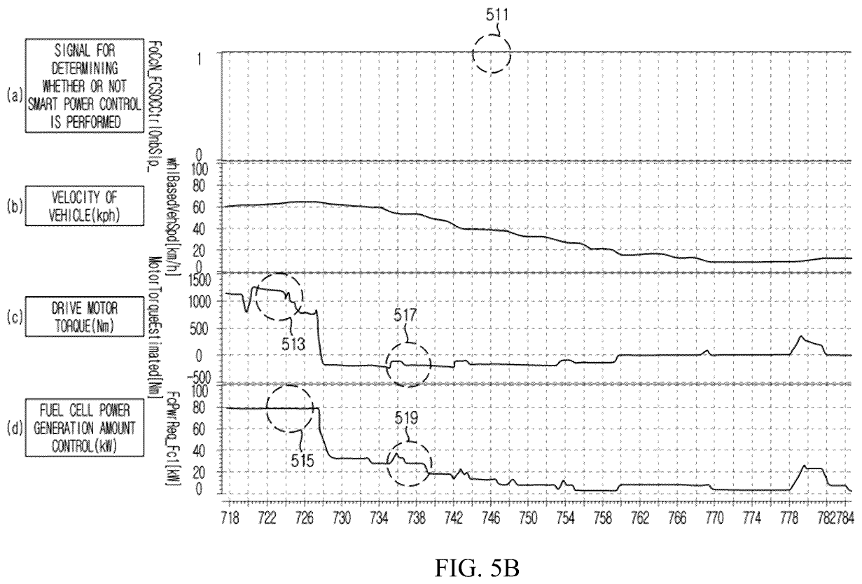

FIG. 5A and FIG. 5B are graphs showing test data according to whether or not fuel cell power generation is controlled during regenerative braking of a vehicle in a current driving segment according to an example of the present disclosure.

As shown in FIG. 5A, when fuel cell power generation control is not applied during a regenerative braking of the vehicle, the vehicle relies solely on motor regenerative braking output to recharge its battery. In this scenario, battery SOC recovery may be limited, leading to an insufficient charge before entering a high-energy-demand segment, such as an extended incline. The test data in FIG. 5A confirms that, under these conditions, the vehicle may fail to secure sufficient SOC, resulting in increased fuel cell load and energy consumption when additional power is required during uphill driving.

In contrast, FIG. 5B shows the impact of applying fuel cell power generation control during the regenerative braking. The test results show that supplementary fuel cell power generation may allow for higher battery SOC retention, ensuring that sufficient charge is available before encountering a high-power-demand condition. The test results show that this approach reduces sudden fuel cell power spikes and stabilizes power distribution, improving overall system efficiency.

Referring to FIG. 5A and FIG. 5B, a method for controlling a fuel cell during regenerative braking of a vehicle according to the present disclosure may perform fuel cell power generation control to secure a battery SOC required for a forward driving segment while the vehicle is running in a smart power control state, determine whether an expected battery charge output value is sufficient, during regenerative braking of the vehicle, and charge the battery together with motor regenerative output by performing fuel cell power generation control.

Specifically, FIG. 5A is a smart power control process when fuel cell power generation control is not performed during regenerative braking of a vehicle. Herein, as fuel cell power generation is controlled during regenerative braking, a battery may be charged only by motor regenerative output.

FIG. 5B is a smart power control process when fuel cell power generation control is performed during regenerative braking of a vehicle. Herein, even when smart power control is performed, it is determined during regenerative braking of a vehicle that a battery rechargeable output is sufficient, and thus fuel cell power generation control is performed together so that both the motor regenerative output and the battery may be charged. In this case, a battery SOC required for a first forward driving segment and a second forward driving segment may be sufficiently secured.

In FIG. 5A and FIG. 5B, (a) is a graph showing a signal for determining whether smart power control is performed. For example, the only difference is whether or not fuel cell power generation control is performed according to regenerative braking of a vehicle, but smart power control is performed in both cases. The graph (a) of FIG. 5A may represent 1 (501), and the graph (a) of FIG. 5B may also represent 1 (511).

In FIG. 5A and FIG. 5B, (b) is a graph showing a velocity of a vehicle that is currently moving, and (c) is a graph showing a torque value according to a drive motor of the vehicle during regenerative braking. In case a vehicle performs regenerative braking since a current driving segment is a downhill segment or a driver reduces velocity, a drive motor may decelerate with a minus torque. Herein, a drive motor torque is a magnitude of torque, which the motor delivers to wheels, and may be directly connected with acceleration performance of the vehicle. Generally, as a motor has a higher torque, faster acceleration may be possible. For example, in (c) of FIG. 5A, in a smart power control state, when the vehicle is driven by drive motor torque (503), fuel cell power generation control may be performed together to secure an expected battery output value required for a forward driving segment (505). In addition, because fuel cell power generation is restricted while the vehicle has regenerative braking (509), a battery is charged only by motor regenerative output, and the graph has a negative value for an extended period of time so that a sufficient battery SOC may not be secured in the forward driving segment (507). On the other hand, in (c) of FIG. 5B, while smart power control is being performed, it is possible to determine whether an expected battery charge output value is sufficient during regenerative braking of the vehicle. Accordingly, even if the vehicle has regenerative braking, both smart power control (517) and fuel cell power generation (519) are performed, and thus the drive motor torque value of the graph (c) may increase step in stages even in a deceleration segment. However, in (c) of FIG. 5B, if regenerative braking is not performed, like in FIG. 5A, the vehicle is driven by drive motor torque (513), fuel cell power generation control may be performed together to secure an expected battery output value required for a forward driving segment (515).

In FIG. 5A and FIG. 5B, (d) is a graph showing fuel cell power generation amount control. A fuel cell power generation amount control value is a value representing a fuel cell power generation amount control value according to whether or not fuel cell power generation is controlled. It may be a value obtained by an expected battery charge/discharge output value through smart power control and a required vehicle output value. Herein, the fuel cell power generation amount may correspond to an amount of power generated by a fuel cell in a fuel cell vehicle, that is, a hydrogen fuel cell vehicle. A fuel cell may consist of a single cell, or a plurality of fuel cells may constitute a stack. For example, as a single cell produces approximately 0.7V of electricity, about 50 cells may be needed to produce 1 kW of electricity. A stack consists of approximately 50 cells connected in series. Accordingly, as each of multiple fuel cells provided herein performs the same function, the graph (d) of FIG. 5A and FIG. 5B expresses fuel cell power generation amount control by assuming that there is one fuel cell.

For example, in (d) of FIG. 5A, during regenerative braking of a vehicle, even if a battery SOC needs to be charged, fuel cell power generation is not controlled so that the graph may have a value of 0 (509) because the vehicle velocity is lowered and the drive motor torque value is reduced (507). On the other hand, in FIG. 5B, in order to sufficiently secure a battery SOC value required for a forward driving segment that is uphill, even if the battery is being charged by regenerative braking (517), fuel cell power generation control may be performed together with smart power control. Accordingly, while the vehicle reduces its velocity in the current driving segment and performs regenerative braking, fuel cell power generation control is performed, and thus a fuel cell power generation control value partially increases in a deceleration segment (519).

For example, when forward driving information is obtained for each segment of two or more forward driving roads, if the present disclosure is applied, on the condition that a first forward driving road and a second forward driving road are uphill and battery SOC charge is expected, fuel cell power generation control may be performed even though the vehicle performs regenerative braking in a current driving segment. Thus, a predicted battery SOC required for driving on the first forward driving segment and the second forward driving segment may be sufficiently secured. In addition, efficiency of power generation in a vehicle running uphill may be improved, and overall performance of the vehicle is expected.

That is, when forward driving information is obtained for each segment of at least two or more forward driving roads, as the present disclosure is applied, on the condition that a first forward driving road and a second forward driving road are long and downhill and battery SOC charge is expected, fuel cell power generation control may be limited, and EV driving may be performed only using a battery output. Thus, it is possible to sufficiently secure a battery SOC that will be charged by regenerative braking in a downhill forward driving segment. Accordingly, as regenerative braking may be maintained for a long time during downhill driving, the performance of a vehicle may be improved during downhill driving, and the overall performance of fuel cells and the vehicle may be expected.

The present disclosure is technically directed to providing a method and device for controlling fuel cell power generation of a moving object by efficiently controlling a battery charge/discharge output value based on information on each segment of a forward driving road acquired from a peripheral device of the vehicle.

In addition, to solve the technical problem of the present disclosure, the present disclosure is directed to providing a method and device for dividing a driving road of a vehicle into segments and controlling fuel cell power generation during regenerative braking according to an expected battery output value required for a front segment.

The technical problems solved by the present disclosure are not limited to the above technical problems and other technical problems which are not described herein will be clearly understood by a person having ordinary skill in the technical field, to which the present disclosure belongs, from the following description.

According to the present disclosure, a method is provided for controlling fuel cell power generation during regenerative braking of a vehicle. The method may comprising: acquiring forward driving information for each of at least two or more forward driving segments of a forward driving road; calculating a required fuel cell output value of a current driving segment based on the acquired forward driving information for each of the segments; determining whether or not to perform fuel cell power generation control, if the current driving segment is a regenerative braking segment; and performing, based on the determining, fuel cell power generation control, even if the current driving segment is the regenerative braking segment.

According to an example of the method of the present disclosure, the method, wherein in order to calculate an expected battery output value of each of the forward driving segments based on the acquired forward driving information, the forward driving information is acquired according to each of the forward driving segments that are divided at least into the current driving segment, a first forward driving segment, and a second forward driving segment.

According to an example of the method of the present disclosure, the method, wherein the determining of whether or not to perform fuel cell power generation control further comprises calculating an expected battery output value and an expected battery charge/discharge energy demand when the current driving segment is a regenerative braking segment, wherein the expected battery output value means an expected battery charge/discharge output value, wherein the expected battery charge/discharge energy demand is determined by multiplying the expected battery charge/discharge output value and an expected future driving time, and wherein a required battery charge/discharge output value is determined by dividing the expected battery charge/discharge energy demand by an expected current segment driving time.

According to an example of the method of the present disclosure, the method, further comprising determining a required fuel cell output value of the current driving segment by correcting the required battery charge/discharge output value by a required vehicle output value for driving, wherein the required fuel cell output value of the current driving segment is determined by adding the required vehicle output value to the required battery charge/discharge output value.

According to an example of the method of the present disclosure, the method, further comprising determining whether or not to control fuel cell power generation during regenerative braking by comparing the required fuel cell output value of the current driving segment and a determined fuel cell power generation demand value during regenerative braking.

According to an example of the method of the present disclosure, the method, further comprising, if battery charge in the current driving segment is determined to be necessary, determining whether or not to control fuel cell power generation during regenerative braking by comparing a value obtained by subtracting a current motor regenerative braking output value from a battery charge limit value and a determined battery charge margin during regenerative braking.

According to an example of the method of the present disclosure, the method, wherein fuel cell power generation control is allowed during regenerative braking in the current driving segment, if the value obtained by subtracting the current motor regenerative braking output value from the battery charge limit value is greater.

According to an example of the method of the present disclosure, the method, wherein fuel cell power generation control is not allowed during regenerative braking, if the battery charge is performed up to or above a predetermined criterion during regenerative braking of the vehicle.

According to an example of the method of the present disclosure, the method, wherein, if the first forward driving segment and the second forward driving segment are long and uphill, the expected battery output value is an expected battery discharge output value, and wherein the expected battery discharge output value is calculated by multiplying a battery efficiency and a value obtained by subtracting an expected fuel cell power generation output value from an expected gradient driving output value during driving.

According to an example of the method of the present disclosure, the method, wherein, if the first forward driving segment and the second forward driving segment are long and downhill, the expected battery output value is an expected battery charge output value, and wherein the expected battery charge output value is determined to be a value obtained by dividing an expected gradient driving output value by a battery efficiency.

According to another example of the present disclosure, a device is provided controlling fuel cell power generation during regenerative braking of a vehicle by controlling a battery output value through forward driving information. The device may comprising: a peripheral device configured to acquire at least one or more of a moving object speed limit of a forward driving road, whether there is a gradient and gradient data as forward driving information; a memory configured to store at least one instruction; and a processor configured to execute the at least one instruction stored in the memory, wherein the processor is further configured to: calculate a required fuel cell output value of a current driving segment based on the acquired forward driving information for each segment, determine whether or not to perform fuel cell power generation control according to whether or not the current driving segment is a regenerative braking segment, and perform, based on the determining, fuel cell power generation control, even if the current driving segment is the regenerative braking segment.

According to an example of the device of the present disclosure, the device, wherein in order to calculate an expected battery output value of each of the forward driving segments based on the acquired forward driving information, the forward driving information is acquired according to each of the forward driving segments that are divided at least into the current driving segment, a first forward driving segment, and a second forward driving segment.

According to an example of the device of the present disclosure, the device, wherein the processor is further configured to determine whether or not to perform fuel cell power generation control according to whether or not the current driving segment is the regenerative braking segment by calculating an expected battery output value and an expected battery charge/discharge energy demand, wherein the expected battery output value means an expected battery charge/discharge output value, wherein the expected battery charge/discharge energy demand is determined by multiplying the expected battery charge/discharge output value and an expected future driving time, and wherein a required battery charge/discharge output value is determined by dividing the expected battery charge/discharge energy demand by an expected current segment driving time.

According to an example of the device of the present disclosure, the device, wherein the processor is further configured to determine a required fuel cell output value of the current driving segment by correcting the required battery charge/discharge output value by a required vehicle output value for driving, wherein the required fuel cell output value of the current driving segment is determined by adding the required vehicle output value to the required battery charge/discharge output value.

According to an example of the device of the present disclosure, the device, wherein the processor is further configured to determine whether or not to control fuel cell power generation during regenerative braking by comparing the required fuel cell output value of the current driving segment and a determined fuel cell power generation demand value during regenerative braking.

According to an example of the device of the present disclosure, the device, wherein the processor is further configured to, if battery charge in the current driving segment is determined to be necessary, determine whether or not to control fuel cell power generation during regenerative braking by comparing a value obtained by subtracting a current motor regenerative braking output value from a battery charge limit value and a determined battery charge margin during regenerative braking.

According to an example of the device of the present disclosure, the device, wherein the processor is further configured to allow fuel cell power generation control to be performed during regenerative braking in the current driving segment, if the value obtained by subtracting the current motor regenerative braking output value from the battery charge limit value is greater.

According to an example of the device of the present disclosure, the device, wherein the processor is further configured to not allow fuel cell power generation control to be performed during regenerative braking, if the battery charge is performed up to or above a predetermined criterion during regenerative braking of the vehicle.

According to an example of the device of the present disclosure, the device, wherein if the first forward driving segment and the second forward driving segment are long and uphill, the expected battery output value is an expected battery discharge output value, and wherein the expected battery discharge output value is calculated by multiplying a battery efficiency and a value obtained by subtracting an expected fuel cell power generation output value from an expected gradient driving output value during driving.

According to an example of the device of the present disclosure, the device, wherein if the first forward driving segment and the second forward driving segment are long and downhill, the expected battery output value is an expected battery charge output value, and wherein the expected battery charge output value is determined to be a value obtained by dividing an expected gradient driving output value by a battery efficiency.

According to the present disclosure, it is possible to provide a method and device for controlling fuel cell power generation of a vehicle by dividing a forward driving segment into at least a first forward driving segment and a second forward driving segment and accurately predicting an expected battery output value required for each segment based on forward driving information of each segment acquired from a peripheral device of the vehicle.

According to the present disclosure, it is possible to provide a method and device for controlling fuel cell power generation of a vehicle by dividing a forward driving segment into at least two segments, that is, a first forward driving segment and a second forward driving segment, calculating an expected battery charge/discharge output value, and controlling fuel cell power generation even during regenerative braking in a current driving segment to sufficiently secure an expected battery output value.

According to the present disclosure, a very heavy large commercial FCEV may maintain its velocity because an expected battery output value for long uphill driving is secured beforehand by increasing an amount of fuel cell power generation before the long uphill driving.

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed:

1. A method for controlling fuel cell power generation of a vehicle, the method comprising:
obtaining driving information about at least two upcoming segments of a road, wherein the at least two upcoming segments of the road are segments of the road to be driven by the vehicle driving on a current segment of the road;
estimating, based on the obtained driving information, a required fuel cell output value of the current segment;
determining, based on the current segment being a segment for regenerative braking and based on the required fuel cell output value, whether to perform fuel cell power generation control of the vehicle; and
controlling, based on the determining, power generation of a fuel cell of the vehicle.

2. The method of claim 1, wherein the obtained driving information is used to determine an expected battery output value for each of the at least two upcoming segments, and wherein, the driving information is obtained based on at least the current segment, a first upcoming segment, and a second upcoming segment.

3. The method of claim 1, wherein the determining whether to perform fuel cell power generation control further comprises estimating, based on the current segment being the segment for regenerative braking, an expected battery output value and an expected battery charge/discharge energy demand,
wherein the expected battery output value corresponds to an expected battery charge/discharge output value,
wherein the expected battery charge/discharge energy demand is determined by multiplying the expected battery charge/discharge output value and an expected future driving time for the at least two upcoming segments, and
wherein a required battery charge/discharge output value is determined by dividing the expected battery charge/discharge energy demand by an expected driving time for the current segment.

4. The method of claim 3, wherein the estimating the required fuel cell output value comprises correcting the required battery charge/discharge output value by a required vehicle output value for driving of the vehicle,
wherein the required fuel cell output value of the current segment is determined based on a sum of the required vehicle output value and the required battery charge/discharge output value.

5. The method of claim 4, further comprising determining whether to perform fuel cell power generation control based on a regenerative braking of the vehicle in the current segment by comparing the required fuel cell output value of the current segment and a determined fuel cell power generation demand value during the regenerative braking.

6. The method of claim 4, further comprising, based on a necessity of battery charge in the current segment, determining whether to perform fuel cell power generation control based on a regenerative braking of the vehicle in the current segment by comparing a value and a determined battery charge margin during the regenerative braking, wherein the value is obtained by subtracting a current motor regenerative braking output value from a battery charge limit value.

7. The method of claim 6, wherein the fuel cell power generation control is configured to be performed during the regenerative braking in the current segment, based on the value being greater than a threshold value.

8. The method of claim 5, wherein the fuel cell power generation control is prohibited during the regenerative braking, based on a battery charge reaching or exceeding a predetermined threshold during the regenerative braking.

9. The method of claim 2, wherein the first upcoming segment and the second upcoming segment correspond to an uphill, and the expected battery output value corresponds to an expected battery discharge output value, and
wherein the expected battery discharge output value is determined by multiplying a battery efficiency and a value that is obtained by subtracting an expected fuel cell power generation output value from an expected gradient driving output value during driving of the vehicle.

10. The method of claim 2, wherein the first upcoming segment and the second upcoming segment correspond to a downhill, and the expected battery output value corresponds to an expected battery charge output value, and
wherein the expected battery charge output value is obtained by dividing an expected gradient driving output value by a battery efficiency.

11. An apparatus for controlling fuel cell power generation of a vehicle, the apparatus comprising:
a peripheral device configured to obtain driving information about at least two upcoming segments of a road, wherein the at least two upcoming segments of the road are segments of the road to be driven by the vehicle driving on a current segment of the road, and wherein the driving information comprises at least one of: a speed limit of a moving object on the road or a presence of a gradient and gradient-related data;
a processor; and
a memory storing at least one instruction that, when executed by the processor, is configured to cause the apparatus to:
estimate, based on the obtained driving information, a required fuel cell output value of the current segment,
determine, based on the current segment being a segment for regenerative braking and based on the required fuel cell output value, whether to perform fuel cell power generation control of the vehicle, and
control, based on the determination, power generation of a fuel cell of the vehicle.

12. The apparatus of claim 11, wherein the obtained driving information is used to determine an expected battery output value for each of the at least two upcoming segments, and wherein, the driving information is obtained based on at least the current segment, a first upcoming segment, and a second upcoming segment.

13. The apparatus of claim 11, wherein the at least one instruction, when executed by the processor, is further configured to cause the apparatus to determine whether to perform fuel cell power generation control by estimating, based on the current segment being the segment for regenerative braking, an expected battery output value and an expected battery charge/discharge energy demand,
wherein the expected battery output value corresponds to an expected battery charge/discharge output value,
wherein the expected battery charge/discharge energy demand is determined by multiplying the expected battery charge/discharge output value and an expected future driving time for the at least two upcoming segments, and
wherein a required battery charge/discharge output value is determined by dividing the expected battery charge/discharge energy demand by an expected driving time for the current segment.

14. The apparatus of claim 13, wherein the at least one instruction, when executed by the processor, is further configured to cause the apparatus to estimate the required fuel cell output value by correcting the required battery charge/discharge output value by a required vehicle output value for driving of the vehicle,
wherein the required fuel cell output value of the current segment is determined based on a sum of the required vehicle output value and the required battery charge/discharge output value.

15. The apparatus of claim 14, wherein the at least one instruction, when executed by the processor, is further configured to cause the apparatus to determine whether to perform fuel cell power generation control based on a regenerative braking of the vehicle in the current segment by comparing the required fuel cell output value of the current segment and a determined fuel cell power generation demand value during the regenerative braking.

16. The apparatus of claim 14, wherein the at least one instruction, when executed by the processor, is further configured to cause the apparatus to, based on a necessity of battery charge in the current segment, determine whether to perform fuel cell power generation control, based on a regenerative braking of the vehicle in the current segment, by comparing a value and a determined battery charge margin during the regenerative braking, wherein the value is obtained by subtracting a current motor regenerative braking output value from a battery charge limit value.

17. The apparatus of claim 15, wherein the at least one instruction, when executed by the processor, is further configured to cause the apparatus to determine the fuel cell power generation control not to be performed during the regenerative braking, based on a battery charge reaching or exceeding a predetermined threshold during the regenerative braking.

18. The apparatus of claim 12, wherein the first upcoming segment and the second upcoming segment correspond to an uphill, and the expected battery output value corresponds to an expected battery discharge output value, and
wherein the expected battery discharge output value is determined by multiplying a battery efficiency and a value that is obtained by subtracting an expected fuel cell power generation output value from an expected gradient driving output value during driving of the vehicle.

19. The apparatus of claim 12, wherein the first upcoming segment and the second upcoming segment correspond to a downhill, and the expected battery output value corresponds to an expected battery charge output value, and
wherein the expected battery charge output value is obtained by dividing an expected gradient driving output value by a battery efficiency.

20. A vehicle comprising:
one or more sensors configured to obtain gradient information about at least two upcoming segments of a road comprising a current segment on which the vehicle is driving;
a battery; and
a processor; and
memory storing instructions that, when executed by the processor, configure the vehicle to:
determine a regenerative charging amount of the battery by performing a regenerative braking operation during driving of the vehicle on the current segment of the road;
determine, based the gradient information and based on the regenerative charging amount, whether to charge the battery by additional power generated by a fuel cell of the vehicle or to discharge the battery; and
control an operation of the vehicle by:
controlling, based on a determination to charge the battery by the additional power generated by the fuel cell, an amount of power generated by the fuel cell of the vehicle; or
controlling, based on a determination to discharge the battery, an amount of charge to be discharged from the battery.
